(19) United States
(12) Patent Application Publication
(10) Pub. No.: US 2025/0265127 A1
(43) Pub. Date: Aug. 21, 2025

(54) SCALABLE AND SEAMLESS EXECUTION OF PYTHON NOTEBOOK PARAGRAPHS ON LARGE-SCALE VMS THROUGH SNAPSHOTTING OF STATE

(71) Applicant: Oracle International Corporation, Redwood Shores, CA (US)

(72) Inventors: Davide Cocco, Obersiggenthal (CH); Sungpack Hong, Palo Alto, CA (US); Alexander Weld, Mountain View, CA (US); Constantin Nicolae, Schneisingen (CH)

(21) Appl. No.: 18/442,302

(22) Filed: Feb. 15, 2024

(51) Int. Cl. G06F 9/50; H04L 67/1097

(52) U.S. Cl. CPC G06F 9/5077; H04L 67/1097

(57) ABSTRACT

Here is acceleration of Python based on novel notebook instrumentation that offloads a computationally intensive paragraph for remote execution. Python notebook paragraphs may be offloaded to custom virtual machines (VMs) by seamless snapshotting of notebook state. This enables the user to selectively execute paragraph(s) locally or on different VMs that cater to the specific computational requirements of each notebook paragraph. Diverse paragraphs may demand varying levels of computational resources. A notebook may run in the usual manner on a chosen VM shape (i.e. configuration of capabilities and capacities) and offload the execution of the most computationally intensive paragraphs to VMs with more powerful shapes when desired, while being able to resume execution in the starting VM in a seamless manner. In this elastic way, the user is able to vertically scale the execution and, for reliability, obtain an isolated (i.e. dedicated, not multitenant) environment.

### FIELD OF THE DISCLOSURE

This disclosure relates to acceleration of interactive Python for data science. Novel notebook instrumentation offloads a computationally intensive paragraph for remote execution.

### BACKGROUND

The current landscape of Python notebooks has a latency problem due to an absence of a user-friendly and low-overhead way to capture and resume a notebook's state in different execution environments. This deficiency becomes particularly evident in data science where computational demands often vary between distinct paragraphs in a same notebook. For example, a machine learning training paragraph often needs significantly more computational power than preliminary data analysis and preprocessing paragraphs.

An ordinary examples of intensive resource allocation for data science is XGBoost model preparation that typically imposes the following demands.
Large datasets: XGBoost needs large datasets to learn complex relationships and achieve high accuracy. Dataset processing may include cleaning, scaling, and feature engineering such as transformations and aggregations.
Model Training: Multiple decision trees are built sequentially, each splitting data based on an information gain criterion. Finding the optimal split at each node involves evaluating numerous possible splits.
Regularization and boosting: Many weak learners are combined into an ensemble.
Memory bottleneck: XGBoost algorithms heavily rely on random access to data during training. Large datasets might not fit entirely in random access memory (RAM), causing frequent and high-latency disk accesses.
Hyperparameter tuning: Finding the optimal combination of hyperparameters values involves numerous training runs.

In cloud environments, the problem is exacerbated. Computer resources are consumed by a powerful virtual or physical computer that is unnecessarily allocated for an entire session, and there is no mechanism to adaptively change the VM configuration during notebook execution. This not only results in excessive resource consumption but, in a multitenant environment such as a public cloud, may also cause starvation (i.e. interference by resource exhaustion) for one tenant by another tenant that share a same resource pool. Even modest concurrent machine learning tasks can strain powerful machines and lead to overallocation (i.e. inefficient resource utilization). For example, as many as nine tenants may concurrently share a virtual or physical computer.

Overallocation is a waste of time and space of computers. If a solution could avoid overallocation, space and time would be saved inside a computer.

### BRIEF DESCRIPTION OF THE DRAWINGS

In the drawings:

FIG. 1 is a block diagram that depicts an example distributed system that accelerates interactive Python execution for data science based on novel notebook instrumentation by a local computer that offloads a computationally intensive paragraph for remote execution on a remote computer;

FIG. 2 is a flow diagram that depicts an example process that a local computer and a remote computer may cooperatively perform to accelerate interactive Python execution for data science based on novel notebook instrumentation for the local computer to offload a computationally intensive paragraph for remote execution on the remote computer;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is acceleration of interactive Python for data science based on novel notebook instrumentation that offloads a computationally intensive paragraph for remote execution. This is a technical solution for efficiently offloading the execution of Python notebook paragraphs to, for example, custom virtual machines (VMs) by seamless snapshotting of notebook state. This innovative approach enables the user to selectively execute paragraph(s) locally or on different VMs that cater to the specific computational requirements of each notebook paragraph. This technology is especially useful in data science and computational workloads, where diverse paragraphs demand varying levels of computational resources. By addressing this challenge, this approach not only optimizes computational resource utilization but also enhances user flexibility and resource efficiency in a cloud environment.

This technical solution solves the problem of resource overallocation, as discussed in the above Background, by allowing the user to run a notebook in the usual manner on a chosen VM shape (i.e. configuration of capabilities and capacities), and offload the execution of the most computationally intensive paragraphs to VMs with more powerful shapes when desired, while being able to resume execution in the starting VM in a seamless manner without the need for specific actions on the part of the user. In this elastic way, the user is able to vertically scale the execution and, for reliability, obtain an isolated (i.e. dedicated, not multitenant) environment. For the cloud provider and cloud tenants, this avoidance of overallocation prevents waste of computer resources.

This approach harnesses Python's globals dictionary to achieve reflective access to the dynamic state within a Python notebook. This novel approach facilitates capture, serialization, and persistence of a snapshot of the notebook's state for seamless resumption of execution in a different environment, which achieves vertical scaling on demand and at a per-paragraph granularity. This innovative functionality relies on the following important components.
Frontend Interaction: A user-friendly frontend element, potentially realized through an ipywidget or a similar graphical interface, serves as an interactive trigger for executing instrumentation responsible for implementing this functionality.
Intermediate Storage: An intermediary persistent storage system, which can be implemented using technologies such as a relational database or a (e.g. JavaScript object notation, JSON) document store, facilitates the exchange of notebook state between the local and remote VMs.

### 1.0 Example Distributed System

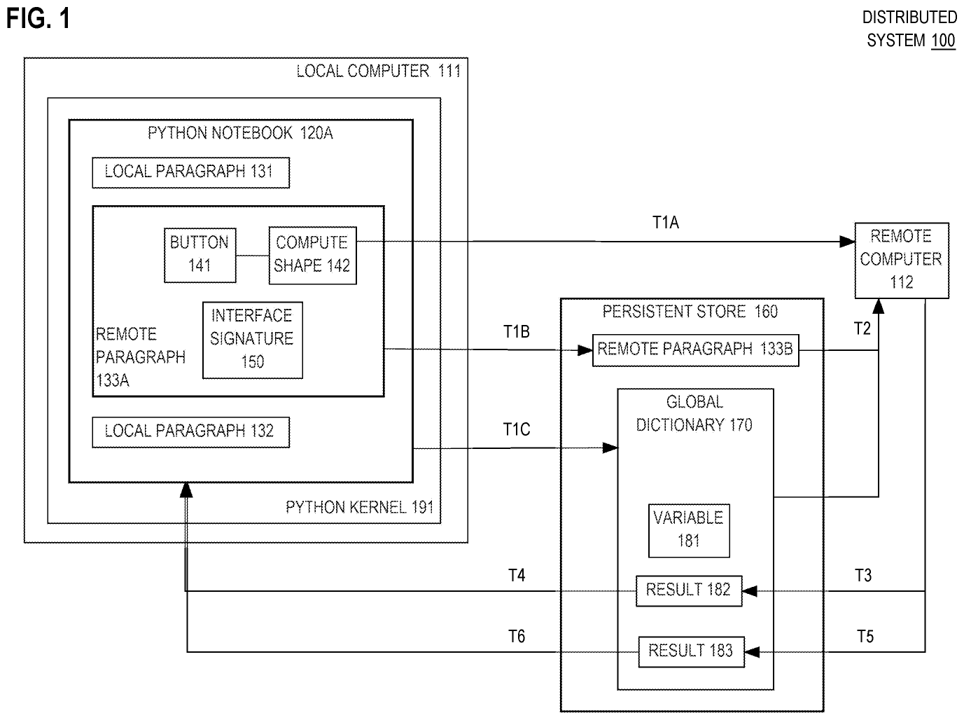

FIG. 1 is a block diagram that depicts example distributed system 100 that accelerates interactive Python execution for data science. Novel notebook instrumentation by local computer 111 offloads a computationally intensive paragraph for remote execution on remote computer 112. Computers 111-112 may be one or more instances of a rack server such as a blade, a mainframe, or a virtual machine (VM).

Herein, a VM may contain its own operating system (OS) and/or simulated central processing unit (CPU) that are independent of the physical computer that hosts the VM. For example, the VM and the host computer may or may not have different instruction set architectures (ISA) and may or may not have different kinds or versions of OS's. Although not shown, computers 111-112 are interconnected by a communication network. Computers 111-112 may have same or different ISAs.

Herein, a program container directly uses and exposes the CPU and OS of the host computer. In an extreme example, either or both of computers 111-112 is a program container that is hosted in a VM that is hosted by a physical computer. Docker containerization is an example of a program container.

### 1.1 Python Paragraphs in Notebooks

Python is a high-level general-purpose scripting (i.e. interpreted) language with dynamic datatypes and garbage collection. Python natively supports important programing paradigms such as structured, object oriented, imperative, and functional. Herein, Python has two distinct source code formats, which are a script and a notebook. A Python script is a sequence of Python statements whose execution is monolithic such that most or all of the script executes to completion. A Python script may persist as a .py text file that has execute permission.

In contrast, a Python notebook is a sequence of Python paragraphs that can be executed individually or as a subset of adjacent paragraphs, such as by interactive selection in an integrated development environment (IDE). A Python paragraph, also referred to herein as a code cell, is a sequence of Python statements. A Python notebook may persist as a .ipynb JavaScript object notation (JSON) text file.

Because a paragraph and a script each is a sequence of statements, operation of a paragraph or script may be somewhat similar. Herein, execution of a script is heavyweight because the execution is independent. For example, an executing script may have its own address space and OS process.

Herein, executions of paragraphs in a notebook is lightweight because the executions occur in a Python kernel that is shared by all Python paragraphs in the notebook. For example, a Python kernel may provide a memory heap that is shared by all Python paragraphs in the notebook. Even if an object in the shared heap is no longer referenced by the paragraph that allocated the object, the Python kernel will not garbage collect the object if another paragraph still references the object. Thus, paragraphs may share data and state such as Python variables. For example, two paragraphs may access a same variable. Herein, all variables are presumed to be global variables, which means that they are accessible anywhere in a notebook and may, for example, be retained in the Python kernel until the kernel is terminated.

In an embodiment, a notebook may contain a mix of Python paragraphs and non-Python paragraphs that may contain source logic of other programming languages such as an interpreted language such as R or JavaScript, or a compiled language such as Java or C++. A paragraph may be repeatedly executed. For example, a first execution of a compiled-language paragraph may automatically entail compilation of the source logic of the paragraph to generate object code of the paragraph, which consists of bytecode or machine instructions that a central processing unit (CPU) can directly execute. A second execution of the already compiled paragraph does not entail compilation because the paragraph's object code is retained and reused, unless the paragraph is edited (i.e. revised) before the second execution, in which case recompilation occurs.

### 1.2 Offload of Remote Paragraph

In the shown example, python notebook 120A is an original and un-instrumented notebook that local computer 111: a) loads and partially executes locally (i.e. within local computer 111) and b) instruments (i.e. inserts instrumentation) to generate remote paragraph 133B to offload to remote computer 112 for remote execution. Local paragraphs 131-132 are optional and demonstrate various scenarios later herein. For example, a notebook may contain only remote paragraph(s).

Herein, execution of any local paragraph occurs in local computer 111, and execution of any remote paragraph occurs in a computer other than local computer 111. For example, separate executions of two remote paragraphs may occur on same or different remote computers such as remote computer 112. Even though the two remote paragraphs may have discrepant resource requirements, the discrepant remote paragraphs may execute together in a same VM that is configured to satisfy the union of both paragraph's resource requirements. For example for a first execution, a first selection may include only the first remote paragraph, and the first execution occurs on a first VM. For a second execution that instead includes both remote paragraphs, a different VM with more resources may instead be used. In other words, different executions of the first paragraph may occur on different VMs depending on which additional remote paragraphs should execute with the first paragraph. Resource-based assignment of remote paragraphs to remote computers is discussed later herein.

For example as discussed later herein, a space intensive remote paragraph may execute on a first remote computer that contains much memory, and a compute intensive remote paragraph may execute on a second remote computer that contains many processing cores. As discussed later herein, a remote computer may be a virtual machine (VM) that is dynamically created and configured with capabilities and capacities to suit particular remote paragraph(s). In a just-in-time (i.e. on demand) example, the VM is not created until the remote paragraph should execute. If the subset of notebook paragraph(s) selected for execution do not include a remote paragraph, no VM is created and no remote execution occurs even if the notebook contains an unselected remote paragraph.

In the shown example, remote paragraph 133A is an original and un-instrumented paragraph that local computer 111 instruments to generate remote paragraph 133B to offload to remote computer 112 for remote execution. Remote paragraph offloading may occur as discussed later herein and as follows. For example, offloading mechanisms may depend on the embodiment. The following is an example Python remote paragraph 133A that begins with two line comments that define interface signature 150 as discussed later herein.
#inputs: depth, dataset_url, preprocessor, load_dataset
#outputs: model
model=RandomForestClassifier (max_depth=depth)
dataset=load_dataset (dataset_url)
dataset=dataset.transform (preprocessor)
model.fit (dataset)

### 1.3 Intermediate Persistent Store

Computers 111-112 are distinct network elements of a communication network. Depending on the embodiment, persistent store 160 may be a distinct network element or may be contained in one of computers 111-112. Persistent store 160 provides more or less temporary storage of data and metadata exchanged between computers 111-112 as discussed below. In alternative embodiments, a) persistent store 160 is absent and replaced by a volatile store or b) persistent store 160 is absent and all data and metadata exchanged between computers 111-112 is directly transferred between computers 111-112.

An advantage of persistent store 160 is that decoupling between computers 111-112 is increased, which increases the reliability of distributed system 100. For example if remote computer 112 is a dynamically created VM, local computer 111 can stage data and metadata in persistent store 160 before remote computer 112 is created. For example: a) persistent store 160 may be a backlog queue for multiple pending offloads by multiple local computers and b) distributed system 100 may be a cloud that contains a central dispatcher that c) dequeues and dispatches one pending offload at a time when a physical computer becomes idle or reclaims sufficient unused resources, and d) the central dispatcher does not decide which physical computer in the cloud should host a VM for an offload until the offload is dequeued. In an embodiment, the cloud is a Simple Linux Utility for Resource Management (SLURM) data science cluster.

If remote computer 112 crashes while executing remote paragraph 133B, the central dispatcher can repeat the same offload to a different remote computer without impacting Python kernel 191. In various embodiments, local computer 111 never communicates directly with remote computer 112 or does not know that remote computer 112 exists. Indirect cooperation of computers 111-112 may occur in the following sequence of times T1-T6.

### 1.4 Example Interactive Offload Lifecycle

Times T1A-T1C may occur in any ordering or concurrently. In the following interactive embodiment, pressing button 141 in a Python IDE causes the sequence of times T1-T6. In various ways, the Python IDE may associate Python components 141-142 with remote paragraph 133A. In an embodiment, Python components 141-142 are custom or proprietary graphical user interface (GUI) widgets at the beginning of remote paragraph 133A that can be preloaded or scraped by Python components 120A and 191 as discussed later herein.

For example, compute shape 142 may specify capabilities and/or resource capacities of remote computer 112. In an embodiment, compute shape 142 specifies discrete capabilities and capacities. In another embodiment, compute shape 142 instead selects one predefined shape from a variety of predefined shapes.

For example, remote computer 112 may be an uncreated VM, and pressing button 141 may cause creation and configuration of remote computer 112 as specified by compute shape 142. If dynamic creation of remote computer 112 is slow, pressing button 141 may, concurrent to time T1A, cause storing of Python components 133B and 170 in persistent store 160 at times T1B-T1C.

Pressing button 141 may cause Python kernel 191 to generate remote paragraph 133B from remote paragraph 133A. Remote paragraphs 133A-B may be identical except that: a) remote paragraph 133B does not contain widgets 141-142, and b) only remote paragraph 133B may contain instrumentation.

### 1.5 Python Dictionary of Global Variables

At time T1C, Python component 120A or 191 stores an exact copy (or an incomplete copy as discussed below) of global dictionary 170 into persistent store 160. Although not shown, an original and identical global dictionary 170 is contained in Python kernel 191.

Global dictionary 170 may be a predefined Python “globals” dictionary that is a hash table of the global variables of Python components 120A and 191. Global dictionary 170 and its global variables may be read or written by Python kernel 191 and by any shown Python component within Python kernel 191. For example, one paragraph may write a global variable, and another paragraph may read the global variable. Thus through global dictionary 170, multiple paragraphs may exchange data, metadata, and state as needed to cooperate. For example, a sequence of paragraphs may operate as respective stages of a Python pipeline through which data, metadata, and state flows from stage to stage.

Time T1A creates remote computer 112 and, at time T2, remote computer 112 creates a Python kernel (not shown) and Python notebook 120B (not shown) that is not a copy of Python notebook 120A. At time T2, those two newly created Python components begin executing in remote computer 112, and they retrieve Python components 133B and 170 from persistent store 160. In other words, time T2 causes Python components 133B and 170 to be loaded and operable in remote computer 112.

### 1.6 Interface Signature

In an embodiment, global dictionary 170 in persistent store 160 is an incomplete copy of the global dictionary in Python kernel 191. For example, interface signature 150 may specify (e.g. by name) a subset of global variables that remote paragraph 133B can read and a subset of global variables that remote paragraph 133B can write. That is, interface signature 150 may specify inputs and outputs of remote paragraph 133B. In that case, global dictionary 170 consists of only a portion of the global dictionary in Python kernel 191. In that case at time T1C, global dictionary 170 in persistent store 160 contains only the subset of global variables that will be inputs that will be read by remote paragraph 133B as specified by interface signature 150.

In an embodiment, interface signature 150 is annotation(s) in a comment at the beginning of remote paragraphs 133A-B, and Python components in computers 111-112 may analyze interface signature 150 by analyzing the annotations in the comment. For example at time T1C, Python kernel 191 may inspect interface signature 150 in remote paragraph 133A to detect which global variables are inputs that should be initially included in global dictionary 170. For example, global variable 181 may be an input that local computer 111 writes and remote computer 112 reads.

In an embodiment, interface signature 150 is not part of a comment and instead is automatically generated based on dataflow analysis by a Python compiler. In that case, interface signature 150 specifies inputs and outputs that are automatically inferred by liveness analysis that statically detects which Python variables should be operated as inputs and outputs.

At time T2, the Python kernel in remote computer 112 copies global dictionary 170 from persistent store 160. Thus at time T2, the more or less initially empty global dictionary in the Python kernel in remote computer 112 is replaced by global dictionary 170, or the contents of global dictionary 170 supplement (i.e. are added to) that initial global dictionary. Between times T2-T3, remote paragraph 133B executes in the Python kernel in remote computer 112, which is faster than executing remote paragraph 133A in local computer 111. In other words, offloading remote paragraph(s) provides acceleration.

### 1.7 Return and use of Offload Results

As remote paragraph 133B executes in remote computer 112, partial results 182-183 are incrementally generated. Partial results 182-183 are global variables that are identified by name as outputs in interface signature 150. At time T1C, global dictionary 170 in persistent store 160 does not contain results 182-183, even though interface signature 150 names results 182-183 as outputs that remote paragraph 133B will eventually generate.

In the following embodiment, asynchronous polling is used to detect completion of execution of remote paragraph 133B. In an alternative embodiment, synchronous remote procedure call (RPC) is instead used to cause execution of remote paragraph 133B and/or detect completion of execution of remote paragraph 133B. Polling operates as follows.

Python notebook 120A may periodically poll global dictionary 170 in persistent store 160 to detect the availability of one or both of results 182-183 in global dictionary 170 in persistent store 160. For example at time T2, Python notebook 120A may begin polling first for only result 182, but result 182 is not yet available. At time T3, remote paragraph 133B in remote computer 112 generates result 182 and inserts result 182 into global dictionary 170 in persistent store 160.

In an embodiment at time T3, the Python kernel in remote computer 112 detects (e.g. by instrumentation in remote paragraph 133B) that remote paragraph 133B has generated result 182 in the global dictionary in the Python kernel in remote computer 112. At time T3, that detection may cause the Python kernel in remote computer 112 to either: a) insert result 182 into global dictionary 170 in persistent store 160 or b) copy some or all of the global dictionary in the Python kernel in remote computer 112 to overwrite (i.e. replace) global dictionary 170 in persistent store 160.

At time T4, Python notebook 120A again polls and detects that result 182 is available in global dictionary 170 in persistent store 160. At time T4, that detection may cause Python notebook 120A to poll for result 183, but result 183 is not yet available in global dictionary 170 in persistent store 160.

At time T5: a) remote paragraph 133B in remote computer 112 generates result 183 in remote computer 112 and b) stores result 183 into global dictionary 170 in persistent store 160. At time T6, Python notebook 120A again polls and detects that result 183 is available in global dictionary 170 in persistent store 160. Thus at time T6, Python notebook 120A has cumulatively retrieved all of results 182-183. Upon completion of time T5, remote computer 112 may be discarded without waiting for time T6.

In the shown embodiment and scenario, local paragraph 131 executes in local computer 111. Then, local computer 111 offloads remote paragraph 133A to remote computer 112 that executes it as remote paragraph 133B that may read input variable 181 and write output results 182-183. Then, local computer 111 retrieves results 182-183 and executes local paragraph 132 that may read results 182-183. For example, times T4 and T6 may insert results 182-183 as global variables into the global dictionary in Python kernel 191.

In that scenario, paragraphs 131, 133B, and 132 execute sequentially in that ordering. For example: a) local paragraph 131 may be unaware of being followed by a remote paragraph, b) local paragraph 132 may be unaware of being preceded by a remote paragraph, and c) remote paragraph 133B may be unaware of being preceded or followed by local paragraphs 131-132. That is, all paragraphs 131-133 use a global dictionary in whichever Python kernel is executing, and persistent store 160 is used to exchange global variables between computers 111-112. In that way, Python notebook 120A may contain any mix of local and remote (i.e. accelerated) paragraphs for sequential execution or interactively selected execution. For example, interactivity may cause remote paragraph 133B to execute before local paragraph 131 executes or after local paragraph 132 executes. Likewise, interactive selection may entirely avoid execution of any of paragraphs 131-133.

### 1.8 Example Offload Activities

As discussed earlier and later herein, offloading remote paragraph 133B for execution may entail one or more of the following activities:
serialization, over a communication network, of a global dictionary of a Python kernel,
persistence, into a network file system or a database, of a global dictionary of a Python kernel,
serialization, over a communication network, of the remote paragraph without the Python notebook,
persistence, into a network file system or a database, of the remote paragraph without the Python notebook,
detection of an interactive button press,
insertion of database authentication logic into the remote paragraph,
insertion of polling logic into the Python notebook, and
instantiation of a remote computer.

In an embodiment with a public cloud such as Oracle, Amazon, or Google, a cloud storage bucket may be used for file persistence instead of a network file system. In an Azure cloud embodiment, a bucket of files may be referred to as a storage blob. Seamless temporary delegation of storage security credentials from local computer 111 to remote computer 112 is an advantage of a cloud bucket.

### 2.0 Example Offload Process

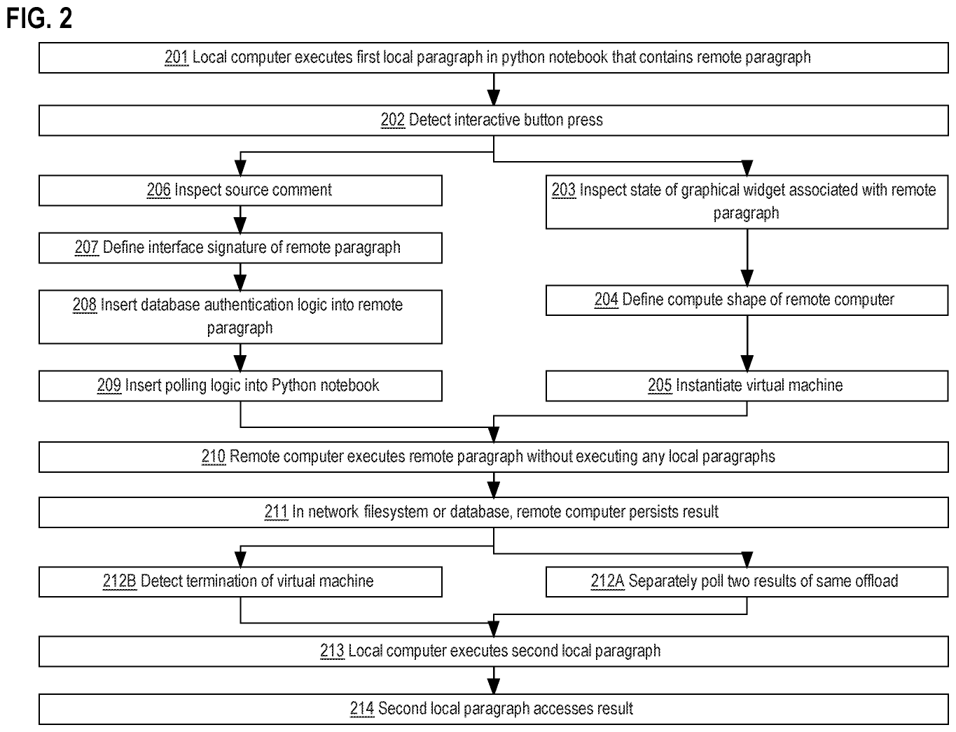

FIG. 2 is a flow diagram that depicts an example process that computers 111-112 may perform to accelerate interactive Python execution for data science. In this process, novel notebook instrumentation by local computer 111 offloads a computationally intensive paragraph for remote execution on remote computer 112. As discussed earlier herein, execution may, for example by interactive selection, include only remote paragraph 133B. For example, Python notebook 120A may lack local paragraphs or contain only unselected local paragraphs.

If no local paragraphs should execute, then local paragraph steps 201 and 213-214 do not occur. For example if no local paragraph should execute before remote paragraph 133B, then the process of FIG. 2 begins at step 202 instead of step 201. Likewise if no local paragraph should execute after remote paragraph 133B, then the process of FIG. 2 ends at step 212 instead of step 214. Python notebook 120A may contain additional local or remote paragraphs. For example, multiple remote paragraphs may be offloaded together for execution together on remote computer 112.

The process of FIG. 2 entails cooperation of computers 111-112 that may be disintermediated (i.e. decoupled) by use of persistent store 160. Local computer 111 performs steps 201-209 and 212-214. Remote computer 112 performs steps 210-211. Herein, performance of an activity by local computer 111 may be implemented as performance of the activity by either of Python component 120A or 191. Likewise, performance of an activity by remote computer 112 may be implemented as performance of the activity by similar Python components.

In one example in step 201 before times T1A-C, local computer 111 executes local paragraph 131 as discussed earlier herein. For example, local paragraph 131 may set the value of variable 131 in local computer 111.

In step 202 more or less immediately before times T1A-C, local computer 111 detects an interactive press of button 141, which causes times T1A-C as discussed earlier herein. In particular, time T1A obtains remote computer 112 and times T1B-C initialize persistent store 160. As discussed earlier herein, that obtaining may precede or follow that initializing, or they may be concurrent.

In particular, in the shown right branch, steps 203-205 perform obtaining remote computer 112 and, in the shown left branch, steps 206-209 perform initializing persistent store 160. That is, the left and right branches may or may not concurrently occur. In particular, the right branch performs time T1A, and the left branch performs times T1B-C, and both branches are performed by local computer 111.

As discussed earlier herein, compute shape 142 may be exposed as a graphical widget that is associated with remote paragraph 133A. Step 203 scrapes (i.e. inspects the state of) the graphical widget. Data scraped by step 203 may be used by step 204 to define compute shape 142 as a data structure that can be used to obtain remote computer 112.

Various embodiments of compute shape 142 may specify any of:
an amount of graphical processing unit (GPU) memory of the second computer exceeding 500 gigabytes,
an amount of byte-addressable nonvolatile memory of the second computer exceeding twenty terabytes,
a count of virtual network interface cards (VNIC) or processor cores of the second computer exceeding a hundred, and/or
an identifier of a predefined compute shape.

In an embodiment or scenario, remote computer 112 already exists and already is sufficiently provisioned to satisfy compute shape 142. In another embodiment or scenario, remote computer 112 does not yet exist, and step 205 instantiates remote computer 112 as a virtual machine as discussed earlier herein. If step the right branch (i.e. time T1A) finishes before the left branch (i.e. times T1B-C), remote computer 112 waits for the left branch to finish.

In the left branch, step 206 inspects an annotation in a source comment in remote paragraph 133A. Data provided by that inspection is used by step 207 to define interface signature 150 as a data structure as discussed earlier herein.

### 2.1 Example Instrumentation of Remote Paragraph

Persistent store 160 may be implemented as a database or a network file system. Only if a database is used, instrumentation step 208 inserts database authentication logic into remote paragraph 133B, which may include open database connectivity (ODBC) details such as any part or parameter of a Java ODBC (JDBC) connection uniform resource locator (URL) such as a database hostname or internet protocol (IP) address, the database's network socket port number, the name of the database or schema, the user account name of the database client account, and the password of that account.

For example, the inserted authentication logic may contain a partial or complete JDBC connection string (i.e. URL). After instrumenting remote paragraph 133B, step 208 stores instrumented remote paragraph 133B into persistent store 160. Step 208 performs time T1B. The following is an example instrumented Python remote paragraph 133B.
#authenticate onto DB class DBClient:
def init (self, connection_string):
def download (self, variable_name):
   return variable
def upload (self, variable_name, variable):
db_client=DBClient (os.environ[“CONN_STRING”]) #Load inputs #Starting from input methods def load_dataset (url):
   #Then input variables
depth=5 #primitives can be copied straight from notebook code
dataset_url=“www.datasets.net/example”
preprocessor=db_client.download (“preprocessor”)
   #Actual paragraph code
model=RandomForestClassifier (max_depth=depth)
dataset=load_dataset (dataset_url)
dataset=dataset.transform (preprocessor) model.fit (dataset)
   #Upload outputs db_client.upload (“model”, model)

In an enhanced security embodiment, step 208 does not involve a database password. For example in an Oracle Cloud Infrastructure (OCI) embodiment, step 208 instead instruments use of a wallet that is a secure container that stores authentication and signing credentials used for accessing the database as a cloud service. In an embodiment, wallet usage is audited and restricted by an OCI vault.

### 2.2 Example Polling Instrumentation

Instrumentation step 209 inserts results polling logic into Python notebook 120A as discussed earlier herein. In the following example Python polling logic: a) output_names contains the variable names of results 182-183, b) check_existence is a poll, and c) globals is the built in Python dictionary of global variables.
start=time ( )
while not numpy.all ([db_client.check_existence (o) for o in output_names]) and
timeout<500000: sleep (5)
timeout=(time ( )−start)
globals.update ({output_name:db_client.download (output_name) for output_name in output_names})

### 2.3 Example Persistence Instrumentation

Although time T1C is performed by the left branch, FIG. 2 does not show a step for time T1C that stores global dictionary 170 into persistent store 160 as discussed earlier herein. It is harmless for the left branch to finish before the right branch finishes. For example, an embodiment may require that the left branch finishes before the right branch starts. The following example global dictionary persistence Python logic implements time T1C.
#authenticate onto DB class DBClient:
def_init_ (self, connection_string):
def download (self, variable_name):
   return variable
def upload (self, variable_name, variable):
def check_existence (self, variable_name):
db_client=DBClient (os.environ[“CONN_STRING”])
#Load inputs
db_client.upload (“preprocessor”, globals[“preprocessor”]) #preprocessor is in the notebook kernel and can be accessed with globals

### 2.4 Offload Execution and Results

Although time T2 is performed immediately before step 210, FIG. 2 does not show a step for time T2 that generates, instruments, and populates Python notebook 120B (not shown in FIG. 1) in the Python kernel in remote computer 112, including copying Python components 133B and 170 from persistent store 160 into Python notebook 120B or the Python kernel in remote computer 112.

Between times T2-T3 in step 210, remote computer 112 executes remote paragraph 133B without executing any local paragraphs. A local paragraph is never contained in a remote computer nor in persistent store 160. For example, Python notebook 120A may be inaccessible by remote computer 112.

As discussed earlier herein, remote computer 112 performs times T3 and T5, and local computer 111 performs times T4 and T6. Thus for times T3-T6, computers 111-112 may concurrently operate. Also as discussed earlier herein, an embodiment may: a) persist each of results 182-183 individually at respective times T3 and T5 and b) poll for each of results 182-183 individually at respective times T4 and T6. Thus, step 211: a) may be repeated to perform each of times T3 and T5 or b) may persist both of results 182-183 together such as when times T3 and T5 are a same single time. If (a), then both of persistence step 211 and polling step 212A may be repeated and interleaved.

Steps 212A-B are mutually exclusive ways for local computer 111 to wait for remote paragraph 133B to finish executing. That is, an embodiment of local computer 111 implements step 212A or 212B but not both.

In an embodiment, step 212A separately (i.e. individually) polls multiple results 182-183 of a same offload (i.e. offloaded execution of remote paragraph 133B) as discussed earlier herein, such as with the above example Python polling logic from instrumentation step 209.

In an embodiment, remote computer 112 is a virtual machine that was created by step 205, and step 212B detects termination of the virtual machine.

After execution of remote paragraph 133B finishes, local computer 111: a) performs times T4 and T6, b) finishes waiting, and c) may or may not automatically or interactively execute local paragraph 132 in step 213 that may occur without re-executing local paragraph 131. For example, local paragraph 132 may read none, one, or both of results 182-183 in step 214.

The process of FIG. 2 may be repeated to execute same or different remote paragraph(s) on a same or different remote computer as discussed earlier herein. For example, a first offloading of remote paragraph 133B may or may not entail instantiating a virtual machine that may or may not be retained for reuse by a second offloading of a same or different remote paragraph.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

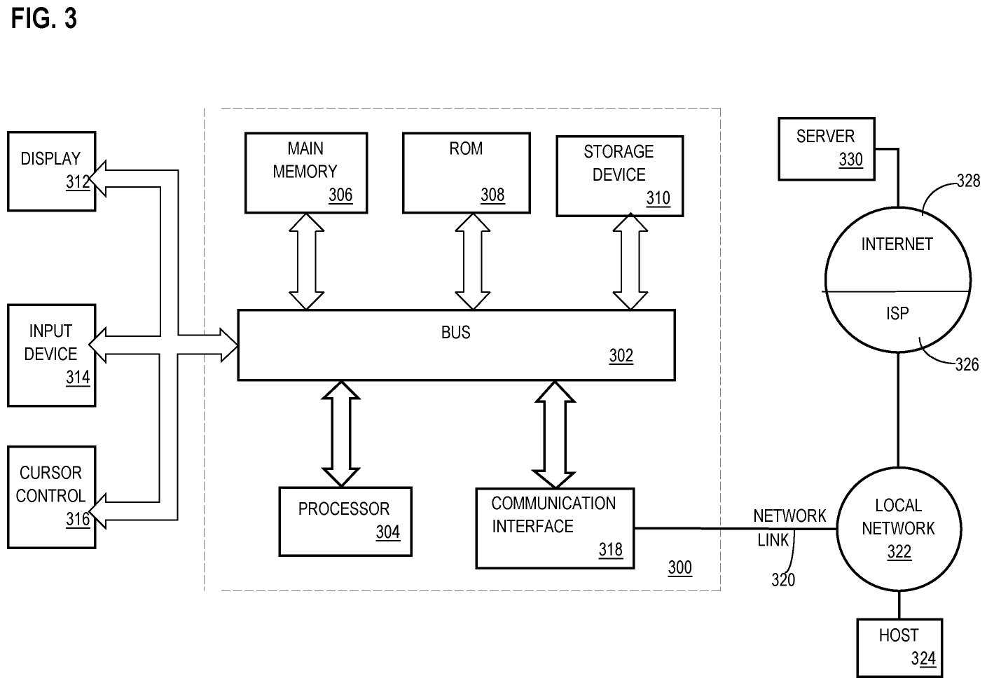

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

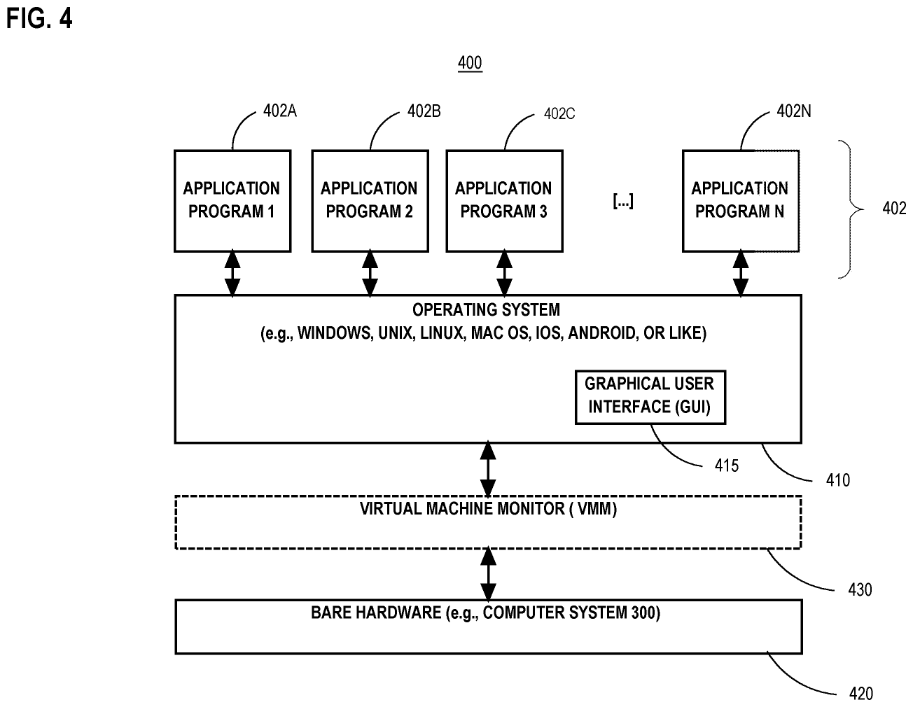

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 400 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
executing, by a first computer, a local paragraph in a Python notebook that contains a remote paragraph; and
executing, by a second computer, the remote paragraph without executing the local paragraph in the second computer.

2. The method of claim 1 wherein:
said local paragraph is a first local paragraph;
the method further comprises executing, by the first computer, after said executing the first local paragraph and said executing the remote paragraph, a second local paragraph in the Python notebook;
said executing the first local paragraph occurs exactly once.

3. The method of claim 2 wherein:
said executing the first local paragraph and said executing the second local paragraph occur in a first Python kernel;
said executing the remote paragraph occurs in a second Python kernel.

4. The method of claim 2 wherein:
the second computer is a virtual machine;
the method further comprises the Python notebook detecting, before said executing the second local paragraph, termination of the virtual machine.

5. The method of claim 2 wherein:
said executing the remote paragraph comprises the second computer persisting, in a network file system or a database, a result;
said executing the second local paragraph comprises accessing the result.

6. The method of claim 5 wherein:
the result contains a first result and a second result;
the method further comprises separately polling the first result and the second result.

7. The method of claim 1 further comprising the Python notebook defining an interface signature of the remote paragraph.

8. The method of claim 7 wherein said defining the interface signature of the remote paragraph comprises the Python notebook inspecting a source comment.

9. The method of claim 8 wherein the remote paragraph contains the source comment.

10. The method of claim 8 wherein the source comment specifies a variable that the remote paragraph will read or write.

11. The method of claim 1 further comprising the Python notebook defining a compute shape of the second computer.

12. The method of claim 11 wherein the compute shape specifies at least one setting selected from a group consisting of:
an amount of graphical processing unit (GPU) memory of the second computer exceeding 500gigabytes,
an amount of byte-addressable nonvolatile memory of the second computer exceeding twenty terabytes,
a count of virtual network interface cards (VNIC) or processor cores of the second computer exceeding a hundred, and
an identifier of a predefined compute shape.

13. The method of claim 11 wherein said defining the compute shape comprises the Python notebook inspecting a state of a graphical widget associated with the remote paragraph.

14. The method of claim 1 further comprising the Python notebook offloading the remote paragraph to the second computer.

15. The method of claim 14 wherein said offloading comprises the Python notebook performing an action selected from a group consisting of:
serialization, over a communication network, of a global dictionary of a Python kernel, persistence, into a network file system or a database, of a global dictionary of a Python kernel, serialization, over a communication network, of the remote paragraph without the Python notebook,
persistence, into a network file system or a database, of the remote paragraph without the Python notebook,
detection of an interactive button press,
insertion of database authentication logic into the remote paragraph,
insertion of polling logic into the Python notebook, and
instantiation of the second computer.

16. The method of claim 1 wherein the first computer and the second computer have different instruction set architectures.

17. One or more non-transitory computer-readable media storing instructions that, when executed by one or more processors, cause:
executing, by a first computer, a local paragraph in a Python notebook that contains a remote paragraph; and
executing, by a second computer, the remote paragraph without executing the local paragraph in the second computer.

18. The one or more non-transitory computer-readable media of claim 17 wherein:
said local paragraph is a first local paragraph;
the instructions further cause executing, by the first computer, after said executing the first local paragraph and said executing the remote paragraph, a second local paragraph in the Python notebook;
said executing the first local paragraph occurs exactly once.

19. The one or more non-transitory computer-readable media of claim 18 wherein:
said executing the remote paragraph comprises the second computer persisting, in a network file system or a database, a result;
said executing the second local paragraph comprises accessing the result.

20. The one or more non-transitory computer-readable media of claim 17 wherein the instructions further cause the Python notebook defining an interface signature of the remote paragraph.

21. The one or more non-transitory computer-readable media of claim 20 wherein said defining the interface signature of the remote paragraph comprises the Python notebook inspecting a source comment.

22. The one or more non-transitory computer-readable media of claim 17 wherein the instructions further cause the Python notebook defining a compute shape of the second computer.

23. The one or more non-transitory computer-readable media of claim 17 wherein the instructions further cause the Python notebook offloading the remote paragraph to the second computer.
